(19) United States
(12) Patent Application Publication
(10) Pub. No.: US 2008/0052952 A1
(43) Pub. Date: Mar. 6, 2008

(54) Method and Apparatus for Drying and Sanitizing Hands

(75) Inventor: William R. Nelson, Thousand Palms, CA (US)

Correspondence Address: PATENT VENTURE GROUP, 10788 CIVIC CENTER DRIVE, SUITE 215, RANCHO CUCAMONGA, CA, 91730, US

(73) Assignee: Aquentium, Inc., Lake Elsinore, CA (US)

(21) Appl. No.: 11/456,344

(22) Filed: Jul. 10, 2006

(51) Int. Cl. F26B 19/00; F26B 21/00

(52) U.S. Cl. 34/554; 34/202; 34/524; 34/572

(57) ABSTRACT

An invention is provided for a hand drying apparatus for drying and sanitizing hands is disclosed. The hand drying apparatus includes a housing having an air intake opening and a heating element situated within the housing capable of heating air drawn into the hand drying apparatus through the air intake opening. Also located within the housing is an air conduit that is in communication with the air intake opening. Further included is a blower that is capable of drawing an air stream into the air conduit through the air intake opening. An ozone gas generator is in communication with the air conduit that is capable of injecting ozone into the air stream to create an ozonated air stream. In this manner, the blower ejects a heated ozonated air stream out of the hand drying apparatus through the air conduit, whereby a user's hands are dried and sanitized.

### BACKGROUND OF THE INVENTION

1. Field of the Invention

This invention relates generally to systems for drying hands, and more particularly to a system for drying and sanitizing hands using ozone.

2. Description of the Related Art

Today, the process of drying hands after washing is conducted in order to keep hands clean. One manner to effectively dry hands after washing is the use of a hand dryer, wherein wet hands are dried using a warm air current, thus obviating the need for paper towels which increase costs.

A typical prior art hand dryer comprises an air blowing unit, which includes a motor and blower rotated by the motor, and heating means. FIG. 1 is a schematic diagram showing a typical prior art hand dryer 100. The prior art hand dryer 100 includes a body case 102 fixed to a wall surface 104 via attachment means 106. Within the body case 102 resides a blower or fan 108, a heating element 110, and a control means 112.

Disposed below the heating element 110 is an air-blowing nozzle 114, which is oriented toward a drying space 116 below the hand dryer 100. An air-intake opening 118 for drawing air into the fan 108 is located at the top of the hand dryer 100. Typically the air-intake opening is provided with a filter frame 120.

In the above structure, when the hand dryer 100 is activated and a wet hand is inserted into the drying space 116, the fan 108 draws air from the air-intake opening 1 18 and passes it through the heating element 110, thus heating the air. The heated air then is ejected from the air-blowing nozzle 114. Water attached to the hand is scattered by the air injected from the air-blowing nozzle 114 to dry the hands.

The drying time for typical prior art hand dryers, such as the hand dryer 100 discussed above, is relatively slow, taking thirty (30) seconds or more to dry a user's hands. The typical commercial hand dryer is rated at 20 amperes at 110 volts which means that it delivers at a rating of 2.2 KW. That is enough energy in 30 seconds to evaporate about 30 grams of water. But the average amount of water on wet hands is three grams or less. Thus, conventional dryers are only about 10 percent energy efficient. The energy loss typically is a result of direction and velocity of the airflow. Attempts to improve energy efficiency in the prior art include providing an enclosure for the hands, recirculating air, predrying the air and use of infrared (IR) radiation as the primary heating means.

Moreover, the prior art hand dryer 100 unfortunately does not provide any form of sanitization when performing the drying operation. Currently, hand hygiene is a large factor in the success of many industries, such as the food and health industries. For example, it is widely recognized in the medical industry that hand hygiene is the simplest and most cost effective means of preventing hospital acquired infections, known as “nosocomial infections.” Studies have demonstrated that enforcement of hand hygiene results in a roughly 50% decrease in nosocomial infection rate. Furthermore, every year a high percentage of food borne illnesses are related to poor hand hygiene in the food service industry.

In view of the foregoing, there is a need for a hand dryer that decreases drying time while increasing hand hygiene. The hand dryer should provide hand sanitization in addition to drying capability. In addition, the hand sanitation should be cost effective and not leave unwanted residue on the user's hands.

### SUMMARY OF THE INVENTION

Broadly speaking, embodiments of the present invention address these needs by providing a hand drying apparatus having sanitation capability. The hand drying apparatus of the embodiments of the present invention utilizes ozone to sanitize the hands while applying a stream of warm air to dry hands. In one embodiment, a hand drying apparatus for drying and sanitizing hands is disclosed. The hand drying apparatus includes a housing having an air intake opening and a heating element situated within the housing. The heating element is capable of heating air drawn into the hand drying apparatus through the air intake opening. Also located within the housing is an air conduit that is in communication with the air intake opening. Further included is a blower that is capable of drawing an air stream into the air conduit through the air intake opening. An ozone gas generator is in communication with the air conduit that is capable of injecting ozone into the air stream to create an ozonated air stream. In this manner, the blower ejects a heated ozonated air stream out of the hand drying apparatus through the air conduit, whereby a user's hands are dried and sanitized.

An additional hand drying apparatus for drying and sanitizing hands is disclosed in a further embodiment of the present invention. As above, the hand drying apparatus includes a housing having an air intake opening and a heating element situated within the housing that is capable of heating air drawn into the hand drying apparatus through the air intake opening. A dual air conduit system having two air conduits is also located within the housing, wherein each air conduit of the dual air conduit system is in communication with the air intake opening. Within the dual air conduit system are two blowers situated such that each air conduit of the dual air conduit system includes a separate blower. Each blower is capable of drawing an air stream through the air intake opening and into the air conduit having the blower. A double shafted motor is situated within the housing and is in mechanical communication with each blower to drive each blower. In addition, an ozone gas generator is situated within the dual air conduit system. The ozone gas generator is capable of injecting ozone into the air stream to create an ozonated air stream. In this manner, the blowers eject heated ozonated air streams out of the hand drying apparatus through each air conduit of the dual air conduit system, whereby a user's hands are dried and sanitized.

A method for drying and sanitizing hands is disclosed in yet a further embodiment of the present invention. The method includes activating a heating element, an ozone gas generator, and a blower, such that the blower creates a heated air stream by drawing air past the heating element. Thereafter, the heated air stream is directed past the ozone gas generator, which injects ozone into the heated air stream to create a heated ozonated air stream. The heated ozonated air stream is then ejected into a drying space, whereby wet hands situated within the drying space are dried and sanitized. Optionally, a user's hands located in the drying space can be detected utilizing a proximity sensor. In this aspect, the proximity sensor can actuate a switch that activates the heating element, ozone gas generator, and blower upon detecting the user's hands in the drying space. Then, upon no longer sensing the user's hands in the drying space, the proximity sensor can deactivate the switch, which shuts off the heating element, ozone gas generator, and blower.

Advantageously, embodiments of the present invention provide hand sanitization while drying. The ozone injected into the heated air stream destroys bacteria residing on the user's hands during the drying process. Because a liquid sanitizing agent is not used in the embodiments of the present invention, no film or other residue is left on hands. Moreover, embodiments of the present invention purify the outside air in the surrounding environment by drawing the outside air into the system, injecting ozone into the air stream, and ejecting the purified, ozonated air out of the system. Furthermore, embodiments of the present invention decrease drying time by use of dual blowers and angled air conduits. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a schematic diagram showing a typical prior art hand dryer;

FIG. 2 is a schematic diagram showing a hand drying system having sanitation capability, in accordance with an embodiment of the present invention;

FIG. 5 is a schematic diagram showing a dual air conduit hand drying system having sanitation capability, in accordance with an embodiment of the present invention;

FIG. 3 is a perspective view of an exemplary squirrel cage blower suitable for use in an embodiment of the present invention;

FIG. 4 is a schematic diagram showing an exemplary corona discharge device for ozone gas generation, in accordance with an embodiment of the present invention; and

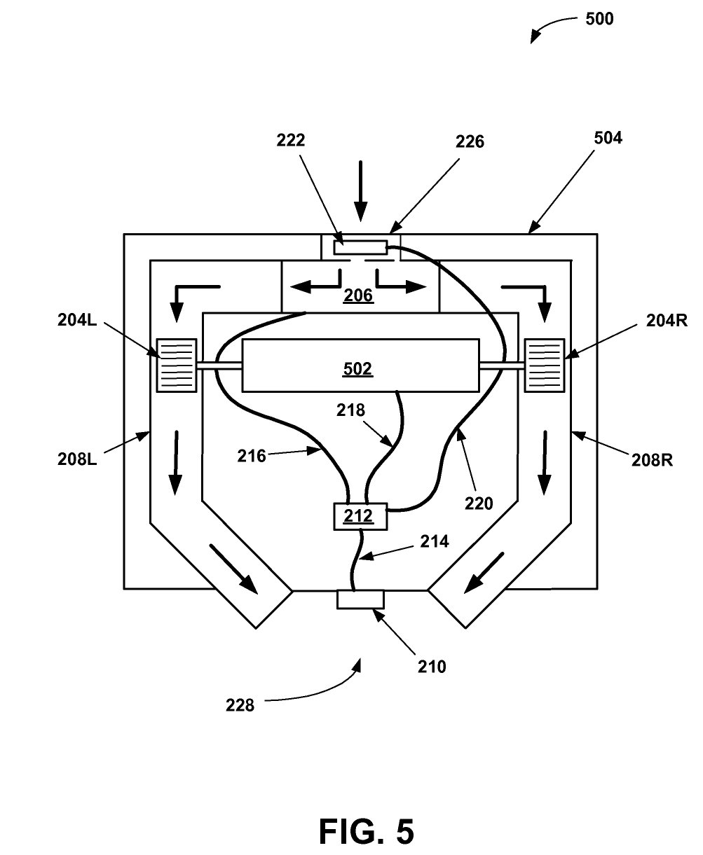

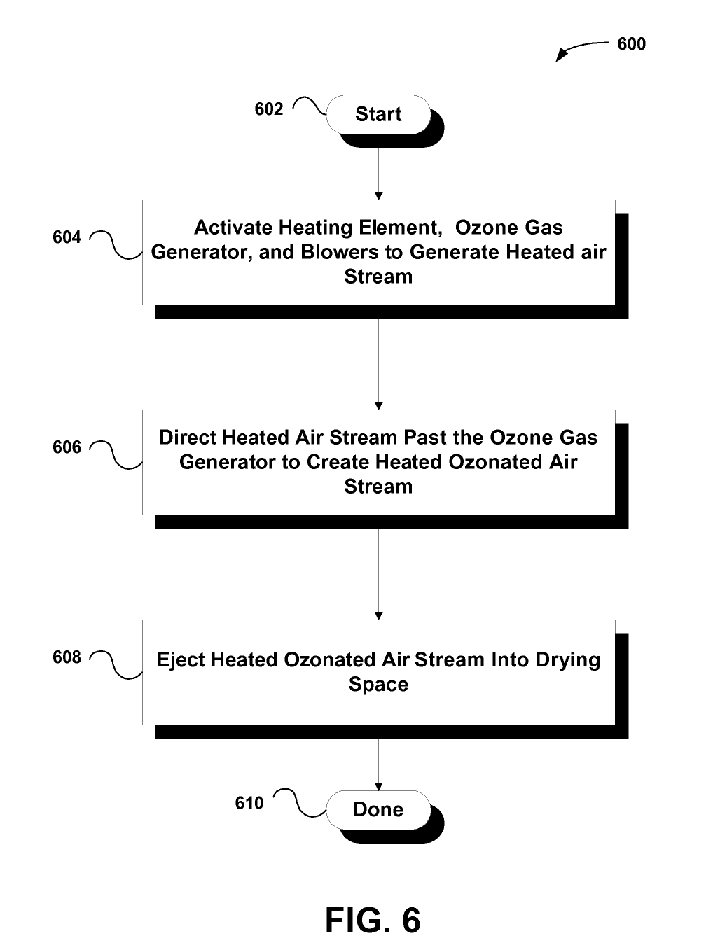

FIG. 5 is a flowchart showing a method for drying and sanitizing hands utilizing a hand drying system in accordance with an embodiment of the present invention.

### DETAILED DESCRIPTION OF THE PREFERRED EMBODIMENTS

An invention is disclosed for a hand drying apparatus having sanitation capability. The hand drying apparatus of the embodiments of the present invention utilizes ozone to sanitize the hands while applying a stream of warm air to dry hands. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

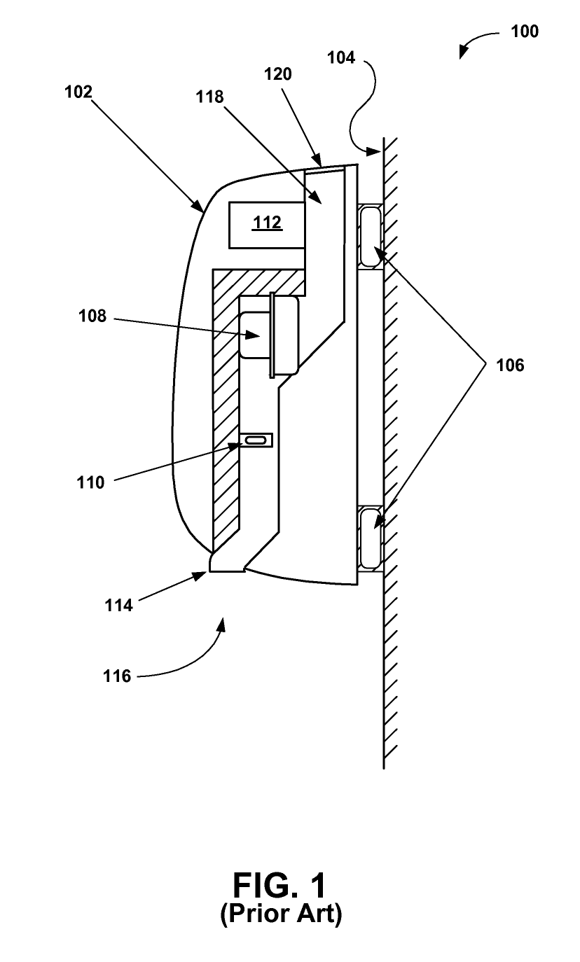

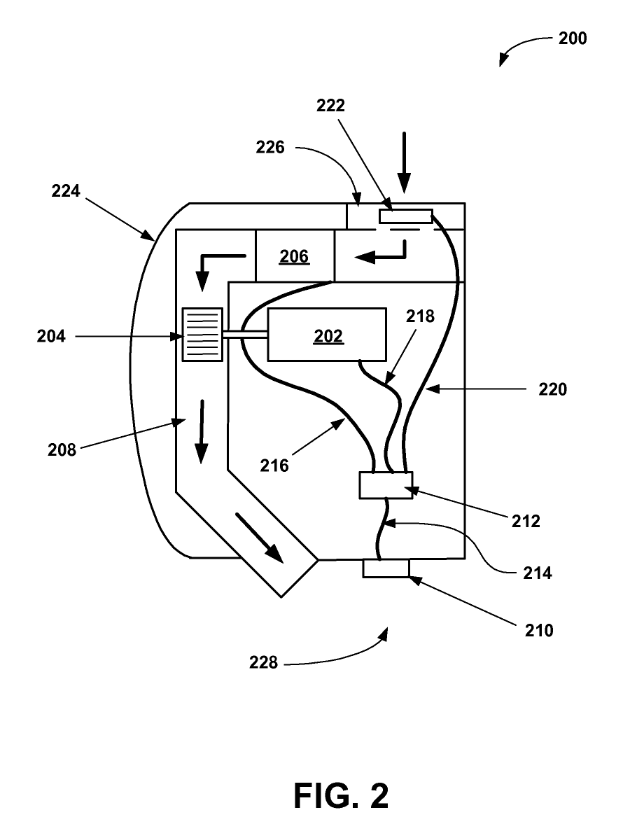

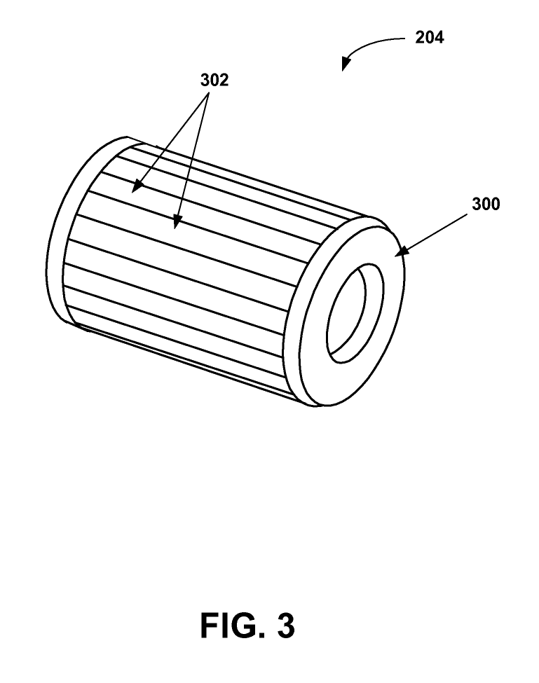

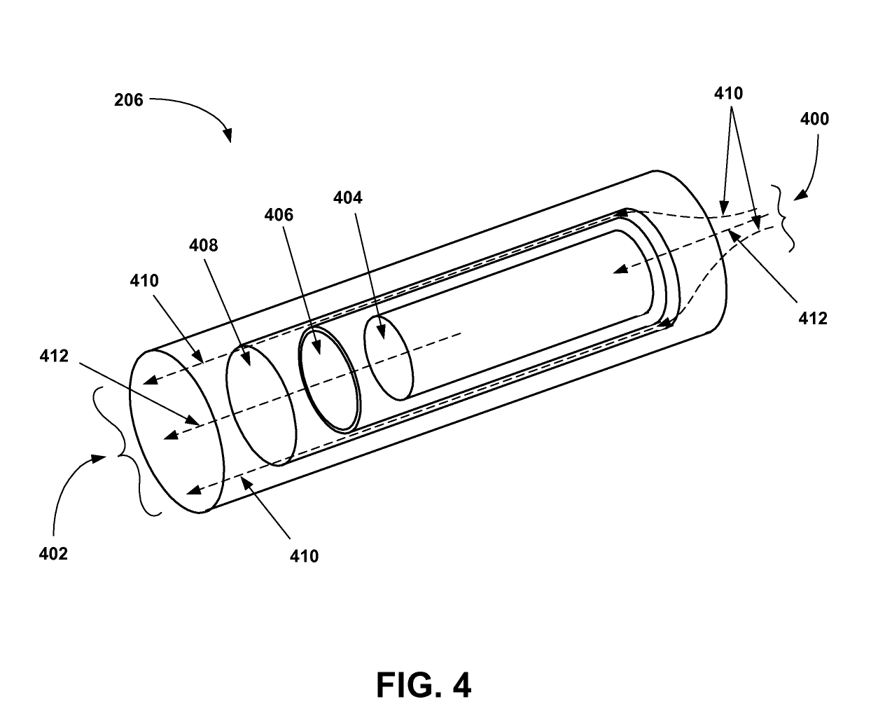

FIG. 1 has been described in terms of the prior art. FIG. 2 is a schematic diagram showing a hand drying system 200 having sanitation capability, in accordance with an embodiment of the present invention. The hand drying system 200 includes a motor 202 coupled to a blower 204 disposed within an air conduit 208. The motor 202 can be any motor capable of driving the blower 204. Exemplary motors include motors rated at 20 amperes at 110 volts delivering at a rating of 2.2 KW, motors rated at 220 volts, or any other motor capable of driving duel blower.

The motor 202 drives the blower 204, which draw outside air into the hand drying system 200 via the air-intake opening 226. The blower 204 can be any rotor or fan capable of moving gas through the hand drying system 200. For example, in one embodiment, the blower 204 can be a squirrel cage fan. FIG. 3 is a perspective view of an exemplary squirrel cage blower 204 suitable for use in an embodiment of the present invention. The squirrel cage blower 204 includes rings 300 arranged at axial ends of a stack of lamination sheets 302. When activated the squirrel cage blower 204 rotates to draw air through the air conduit of the hand drying system.

Referring back to FIG. 2, situated within the air-intake opening 226 is a heating element 222. Disposed within the air conduit 208 is an ozone gas generator 206, which is in communication with the air-intake opening 226. Ozone, or O₃, is an unstable molecule that can be formed by subjecting ordinary molecular oxygen to ultraviolet radiation or to forms of electric discharge (such as coronas and sparks). Ozone quickly breaks down, reverting to molecular oxygen or reacting with surrounding species, and so cannot easily be stored. Thus, for a system to be practical, ozone should be generated on site at the time of use. As such, embodiments of the present invention include an ozone gas generator 206, which can be any apparatus capable of generating ozone gas (O₃). For example, in one embodiment, the ozone gas generator 206 is a corona discharge device.

FIG. 4 is a schematic diagram showing an exemplary corona discharge device 206 for ozone gas generation, in accordance with an embodiment of the present invention. The cylindrical electrode structure allows the corona discharge device 206 to fit and operate properly within the air conduit of the hand drying system. The corona discharge device 206 converts outside air 400 into an output gas 402 containing ozone. The corona discharge device 206 includes a conductive surface 404 which forms an inner electrode along the inner wall of a dielectric tube 406. The dielectric tube 406 may be constructed from a glass, such as pyrex glass, or any other suitable dielectric solid. A concentric negative stainless steel tube 408 is concentrically wrapped around the outer circumference of the dielectric tube 406 forming an outer electrode having a relatively large surface area.

In operation, outside air 400 is directed parallel to the axis of the negative stainless steel tube 408 and the dielectric tube 406. A high voltage AC signal, HVAC, is applied across the inner and outer electrodes 404 and 408. The HVAC signal periodically generates a corona discharge between the inner and outer electrodes 404 and 408. The strength of the corona field between the electrodes 404 and 408 is heightened by the presence of the dielectric tube 406 therebetween. As a result, the outside air 410 that travels between the outer wall of the dielectric tube 406 and the inner wall of the negative stainless steel tube 408 has its oxygen molecules ionized leading to the production of ozone O₃. In addition, outside air 412 traveling along the inner wall of the conductive surface 404, which forms an inner electrode, provides cooling for the corona discharge device 206.

Referring back to FIG. 2, a switch 212 controls power to the motor 202, ozone gas generator 206, and heating element 222 via power wires 216, 218, and 220. The switch 212 receives activation signals from a proximity sensor 210 located on a housing 224 via data line 214. The proximity sensor 210 is capable of sensing when a user's hands are located beneath the hand drying system 200, referred to hereinafter as a hand drying space 228. The proximity sensor can be any sensor capable of sensing when an object is near the sensor, such as a photoelectric proximity sensor. A photoelectric proximity sensor uses a light-beam generator to generate a light beam that reflects from an object and is picked up by a photodetector. Typically, the light beam is modulated at a specific frequency, and the detector has a frequency-sensitive amplifier that responds only to light modulated at that frequency. This prevents false imaging that might otherwise be caused by lamps or sunlight. Other usable proximity sensors include acoustic proximity sensors, which operate on a similar principle as sonar, capacitive proximity sensor, which utilize radio-frequency, and any other proximity sensor capable of sensing when an object is near the sensor 210, as will be apparent to those skilled in the art after a careful reading of the present disclosure. To enhance drying performance, embodiments of the present invention can also employ a dual air conduits system utilizing two blowers, as illustrated next with reference to FIG. 5.

FIG. 5 is a schematic diagram showing a dual air conduit hand drying system 500 having sanitation capability, in accordance with an embodiment of the present invention. The hand drying system 500 includes a double shafted motor 502 coupled to two blowers 204L and 204R disposed within a dual air conduit system comprising two air conduits 208L and 208R. The double shafted motor 502 can be any motor capable of driving the dual blowers 204L and 204R. Exemplary motors include double shafted motors rated at 20 amperes at 110 volts delivering at a rating of 2.2 KW, a double shafted motors rated at 220 volts, or any other double shafted motor capable of driving duel blowers.

The double shafted motor 502 drives the blowers 204L and 204R, which draw outside air into the hand drying system 500 via the air-intake opening 226. The blowers 204L and 204R can be any rotor or fan capable of moving gas through the hand drying system 200. For example, in one embodiment, each blower 204L and 204R can be a squirrel cage fan, as discussed above with reference to FIG. 3.

Situated within the air-intake opening 226 is a heating element 222. Disposed within the air conduits 208L and 208R of dual air conduit system is an ozone gas generator 206, which is in communication with the air-intake opening 226. As mentioned previously, embodiments of the present invention include an ozone gas generator 206, which can be any apparatus capable of generating ozone gas (O₃), such as a corona discharge device.

A switch 212 controls power to the motor 502, ozone gas generator 206, and heating element 222 via power wires 216, 218, and 220. The switch 212 receives activation signals from a proximity sensor 210 located on a housing 504. As discussed previously, the proximity sensor can be any sensor capable of sensing when an object is near the sensor, such as a photoelectric proximity sensor, acoustic proximity sensor, capacitive proximity sensor, or any other proximity sensor capable of sensing when an object is near the sensor 210, as will be apparent to those skilled in the art after a careful reading of the present disclosure.

Embodiments of the present invention provide hand sanitization in addition to drying capability. The beneficial properties of ozone have been recognized and applied for many decades. Ozone has been used as a disinfectant to destroy bacteria and certain viruses in drinking water and in air, as a deodorizer for air and sewage gases, as a bleach, and as an oxidizing agent in various chemical processes. Here, embodiments of the present invention utilize ozone to sanitize the hands while applying a stream of warm air to dry hands, as detailed in the operations set forth below.

FIG. 6 is a flowchart showing a method 600 for drying and sanitizing hands utilizing a hand drying system in accordance with an embodiment of the present invention. In an initial operation 602, preprocess operations are performed. Preprocess operations can include, for example, mounting the hand drying system to wall, adjusting the ozone generation rate, adjusting blower rotation speed and other preprocess operations that will be apparent to those skilled in the art after a careful reading of the present disclosure.

In operation 604, the heating element, ozone gas generator, and blowers are activated. Turning to FIG. 5, when a user places their hands beneath the hand drying system 500, that is, within the hand drying space 228, the proximity sensor 210 activates. The proximity sensor 210 actuates the switch 212 allowing outside power to be supplied to the power wires 216, 218, and 220. In response, power is supplied to the double shafted motor 502, the ozone gas generator 206, and the heating element 222. The double shafted motor 502 drives the blowers 204L and 204R, which draw outside air thru the air-intake opening 226 and across the heating element, creating a heated air stream.

Referring back to FIG. 6, the heated air stream is directed past the ozone gas generator, wherein the ozone gas generator injects ozone into the heated air stream creating a heated ozonated air stream, in operation 606. As illustrated in FIG. 5, an ozone gas generator 206 is situated within the air conduits 208L and 208R in communication with an air-intake opening 226. Because ozone breaks down quickly, reverting to molecular oxygen or reacting with surrounding species, the ozone is generated within the hand drying system 500 at the time of use. When using a corona discharge device as an ozone gas generator 206, the heated air stream is directed parallel to the axis of a negative stainless steel tube and an inner dielectric tube. A HVAC is applied across inner and outer electrodes, which generates a corona discharge between the electrodes. The dielectric tube heightens the strength of the corona field between the electrodes. Air that travels between the outer wall of the dielectric tube and the inner wall of the negative stainless steel tube has its oxygen molecules ionized leading to the production of ozone O₃. In this manner, the ozone gas generator 206 injects ozone into the heated air stream, creating a heated ozonated air stream.

Referring back to FIG. 6, in operation 608, the heated ozonated air stream is ejected from the hand drying system into the hand drying space, drying and sanitizing a user's hands. As illustrated in FIG. 5, the heated ozonated air stream is directed to the user's hands from two discrete directions by bends in the two air conduits 208L and 208R. In this manner, water is “pushed” off the user's hands, which decreases overall drying time.

In operation 610, post process operations are performed. Post process operations can include, for example, deactivating the hand drying system. In one embodiment, the proximity sensor deactivates the switch when the user's hands are removed from the drying space. This action shuts off the double shafted motor, heating element, and ozone gas generator. Advantageously, embodiments of the present invention provide hand sanitization while drying. The ozone injected into the drying air stream destroys bacteria residing on the user's hands during the drying process. Because a liquid sanitizing agent is not used in the embodiments of the present invention, no film or other residue is left on hands. Moreover, embodiments of the present invention purify the outside air in the surrounding environment by drawing the outside air into the system, injecting ozone into the air stream, and ejecting the purified, ozonated air out of the system. Furthermore, embodiments of the present invention decrease drying time by use of dual blowers and angled air conduits.

Although the foregoing invention has been described in some detail for purposes of clarity of understanding, it will be apparent that certain changes and modifications may be practiced within the scope of the invention. Accordingly, the present embodiments are to be considered as illustrative and not restrictive, and the invention is not to be limited to the details given herein, but may be modified within scope and equivalents of the invention.

What is claimed is:

1. A hand drying apparatus for drying and sanitizing hands, comprising:
a housing having an air intake opening;
a heating element situated within the housing, the heating element capable of heating air drawn into the hand drying apparatus through the air intake opening;
an air conduit located within the housing, the air conduit in communication with the air intake opening;
a blower capable of drawing an air stream into the air conduit through the air intake opening; and
an ozone gas generator in communication with the air conduit, the ozone gas generator capable of injecting ozone into the air stream to create an ozonated air stream, wherein the blower ejects a heated ozonated air stream out of the hand drying apparatus through the air conduit, whereby a user's hands are dried and sanitized.

2. A hand drying apparatus as recited in claim 1, wherein the air conduit forms a portion of a dual air conduit system, each air conduit of the dual air conduit system in communication with the air intake opening.

3. A hand drying apparatus as recited in claim 2, further comprising an additional blower in communication with the dual air conduit system, wherein each air conduit of the dual air conduit system includes a separate blower.

4. A hand drying apparatus as recited in claim 1, wherein the ozone gas generator is a corona discharge device having a cylindrical electrode structure.

5. A hand drying apparatus as recited in claim 1, further comprising a proximity sensor located on the housing, the proximity sensor capable of sensing when a user's hands are near the proximity sensor.

6. A hand drying apparatus as recited in claim 5, wherein the proximity sensor actuates a switch that allows power to be provided to the ozone gas generator, and the heating element.

7. A hand drying apparatus as recited in claim 1, further comprising a motor situated within the housing and in mechanical communication with blower, the motor capable of driving the blower.

8. A hand drying apparatus for drying and sanitizing hands, comprising:
a housing having an air intake opening;
a heating element situated within the housing, the heating element capable of heating air drawn into the hand drying apparatus through the air intake opening;
a dual air conduit system having two air conduits, each air conduit in communication with the air intake opening;
two blowers located within the dual air conduit system, wherein each air conduit of the dual air conduit system includes a separate blower, each blower capable of drawing an air stream into the air conduit having the blower through the air intake opening;
a double shafted motor situated within the housing and in mechanical communication with each blower, the double shafted motor capable of driving each blower; and
an ozone gas generator situated within the dual air conduit system, the ozone gas generator capable of injecting ozone into the air stream to create an ozonated air stream, wherein the blowers eject heated ozonated air streams out of the hand drying apparatus through each air conduit of the dual air conduit system, whereby a user's hands are dried and sanitized.

9. A hand drying apparatus as recited in claim 8, wherein the ozone gas generator is a corona discharge device having a cylindrical electrode structure.

10. A hand drying apparatus as recited in claim 8, further comprising a switch in electrical communication with the heating element, the double shafted motor, and the gas generator.

11. A hand drying apparatus as recited in claim 10, further comprising a proximity sensor located on the housing and in electrical communication with the switch, the proximity sensor capable of sensing when a user's hands are near the proximity sensor.

12. A hand drying apparatus as recited in claim 11, wherein the proximity sensor actuates the switch upon sensing a user's hands, wherein the actuated switch allows power to be provided to the heating element, the double shafted motor, and the ozone gas generator.

13. A hand drying apparatus as recited in claim 12, wherein the proximity sensor deactivates the switch upon no longer sensing the user's hands near the proximity sensor.

14. A hand drying apparatus as recited in claim 14, wherein the deactivated switch shuts off the heating element, the double shafted motor, and the ozone gas generator.

15. A method for drying and sanitizing hands, comprising the operations of:
activating a heating element, an ozone gas generator, and a blower, wherein the blower creates a heated air stream by drawing air past the heating element;
directing the heated air stream past the ozone gas generator, wherein the ozone gas generator injects ozone into the heated air stream creating a heated ozonated air stream;
ejecting the heated ozonated air stream into a drying space, whereby wet hands situated within the drying space are dried and sanitized.

16. A method as recited in claim 15, further comprising the operation of detecting a user's hands located in the drying space utilizing a proximity sensor.

17. A method as recited in claim 16, wherein the proximity sensor actuates a switch that activates the heating element, the ozone gas generator, and the blower upon detecting the user's hands in the drying space.

18. A method as recited in claim 17, wherein the proximity sensor deactivates the switch upon no longer sensing the user's hands in the drying space.

19. A method as recited in claim 18, wherein the deactivated switch shuts off the heating element, the ozone gas generator, and the blower.
